(19) United States
(12) Patent Application Publication
(10) Pub. No.: US 2021/0304039 A1
(43) Pub. Date: Sep. 30, 2021

(54) METHOD FOR CALCULATING THE IMPORTANCE OF FEATURES IN ITERATIVE MULTI-LABEL MODELS TO IMPROVE EXPLAINABILITY

(71) Applicant: Hitachi, Ltd., Tokyo (JP)

(72) Inventors: Hsiu-Khuern TANG, San Jose, CA (US); Laleh JALALI, Santa Clara, CA (US)

(21) Appl. No.: 16/828,490

(22) Filed: Mar. 24, 2020

(51) Int. Cl. G06N 5/04; G06N 20/00

(52) U.S. Cl. CPC G06N 5/045; G06N 20/00

(57) ABSTRACT

Example implementations described herein involve systems and methods for calculating the importance of each iteration and of each input feature for multi-label models that optimize a multi-label objective function in an iterative manner. The example implementations are based on the incremental improvement in the objective function rather than an application-specific metric such as accuracy.

### BACKGROUND

### Field

The present disclosure is generally directed to features for machine learning, and more specifically, to determining feature importance for multi-label models.

### Related Art

In multi-label learning, the goal is to build a classification model for instances in which each data instance may have multiple classes of labels. For example, a news article may cover multiple topics and a patient may have multiple diagnoses. Approaches to this problem can be roughly grouped into two categories: those that transform the problem into a number of independent binary classification problems and those that handle the multi-label data directly. The latter includes models that optimize an overall objective function in an iterative manner.

Related art implementations focus on feature dimension reduction for multi-label models. Such related art implementations select a subset of features or create new ones prior to fitting the model and hence do not provide a method to calculate the feature importance of a multi-label model. In the related art, there are algorithms that calculate a value for each feature to be used for feature selection. Another related art implementation combines mutual information with a metric called max-dependency and min-redundancy to select the best features, treating each label independently. Further related art implementations use a Bayesian network structure to exploit the conditional dependencies of the labels and then construct a classifier for each label by incorporating its parent labels as additional features. In other related art implementations, features are selected by maximizing the dependency between the selected features and the labels. There are also related art algorithms that transform the features into a lower-dimensional space using clustering.

Other related art implementations only work in special cases or have other limitations. In the related art implementations involving the impurity-based method, the method applies to decision tree models that maximize the decrease in impurity, and to ensembles of such models, but it is not clear how to modify such implementations to work with a general multi-label objective function.

In related art implementations involving the permutation method, such implementations are applied to an application-specific metric such as accuracy. While it can be applied to a general multi-label objective function, which will give a measure of the overall feature importance, it is not clear how to use such implementations to get a feature importance for each label that is based on the objective function.

### SUMMARY

Example implementations described herein involve a method for calculating the importance of each iteration and of each input feature for such models. Such example implementations are based on the incremental improvement in the objective function rather than an application-specific metric such as accuracy.

Such example implementations allow users to quantify how important each feature is for predicting each label. As a result, model explainability may be improved. In addition, the iteration importance can be used to cluster the labels and reduce the number of labels for modeling.

In each iteration, the absolute or relative decrease in the objective function value is utilized as a measure of the overall importance of that iteration. By writing the objective function as a weighted average of contributions from different labels, the example implementations can be adapted to define the iteration importance for each label. The idea behind this is that minimizing the overall objective function will in general have different effects on the different contributions, and those effects can be used as a measure of the iteration importance for each label.

The iteration importance can be utilized to assign weights to the features used in that iteration. Such assignments can be facilitated through the “leave-out” method as described herein. The importance of each feature is set to the sum of the weights assigned to that feature over the iterations.

The example implementations can be utilized in conjunction with models composed of multiple simpler terms where each iteration fits or updates one of those terms, such as generalized additive models and boosted models.

Aspects of the present disclosure can include a computer implemented method for determining feature importance values for each label for a multi-label model configured to provide model scores for each label in the multi-label model based on an input feature vector, the method involving executing an objective function on the model scores for each label to determine a risk associated with each label; executing an iterative process involving the features represented in the input feature vector, wherein for each iteration: determining an iteration importance value for the each label for the each iteration from a risk reduction that is derived from the risk associated with the each label; and assigning weights for the features associated with the each label based on the iteration importance value for that label for the each iteration.

Aspects of the present disclosure can include a non-transitory computer readable medium, storing instructions for determining feature importance values for each label for a multi-label model configured to provide model scores for each label in the multi-label model based on an input feature vector, the instructions involving executing an objective function on the model scores for each label to determine a risk associated with each label; executing an iterative process involving the features represented in the input feature vector, wherein for each iteration: determining an iteration importance value for the each label for the each iteration from a risk reduction that is derived from the risk associated with the each label; and assigning weights for the features associated with the each label based on the iteration importance value for that label for the each iteration.

Aspects of the present disclosure can include a system for determining feature importance values for each label for a multi-label model configured to provide model scores for each label in the multi-label model based on an input feature vector, the system involving means for executing an objective function on the model scores for each label to determine a risk associated with each label; means for executing an iterative process involving the features represented in the input feature vector, wherein for each iteration: means for determining an iteration importance value for the each label for the each iteration from a risk reduction that is derived from the risk associated with the each label; and means for assigning weights for the features associated with the each label based on the iteration importance value for that label for the each iteration.

Aspects of the present disclosure involve an apparatus configured to determine feature importance values for each label for a multi-label model configured to provide model scores for each label in the multi-label model based on an input feature vector, the apparatus involving a processor configured to execute an objective function on the model scores for each label to determine a risk associated with each label; execute an iterative process involving the features represented in the input feature vector, wherein for each iteration: determine an iteration importance value for the each label for the each iteration from a risk reduction that is derived from the risk associated with the each label; and assign weights for the features associated with the each label based on the iteration importance value for that label for the each iteration.

### BRIEF DESCRIPTION OF DRAWINGS

FIG. 1 illustrates an example of the multi-label learning problem.

FIGS. 2(A) and 2(B) illustrate flowcharts to calculate the iteration importance and feature importance of a model that minimizes a multi-label objective function in an iterative manner, in accordance with an example implementation. FIG. 2(A) is for calculating these values for each label and FIG. 2(B) is for calculating these values for the overall model.

FIG. 3 illustrates an example output from the flow of FIGS. 2(A) and 2(B), in accordance with an example implementation.

FIG. 4 illustrates an example assignment method in accordance with an example implementation.

FIG. 5 illustrates an example of a matrix of iteration importance values, in accordance with an example implementation.

FIG. 6 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

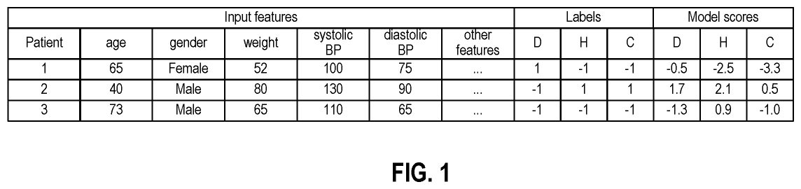

FIG. 1 illustrates an example of the multi-label learning problem. In the example of FIG. 1, there are K=3 potential diagnoses for patients, which are diabetes (D), heart disease (H), and cholesterol problems (C). The features for each patient are age, gender, weight, and so on.

In multi-label learning, the goal is to predict the set of labels associated with a given feature vector x. The set of possible labels is assumed to be fixed. If there are K possible labels, the labels for any data instance may be represented as the label vector y=(y₁, y₂, . . . , y_{K}), where yₗ=1 if label l is present and yₗ=−1 otherwise. Multi-label algorithms typically learn real-valued score functions fₗ(x), l=1, 2, . . . , K, where it is desired that fₗ(x) be large when label l is present and small when it is not.

The example implementations described herein are applicable to any model for the scores fₗ(x) that is fit iteratively to numerically optimize an objective function evaluated over the training data that is a weighted average of contributions from different labels. Without loss of generality, it is assumed that the objective function is to be minimized. One example is AdaBoost.MH, which fits an additive model for the scores,

$${f}_{ℓ} ( x ) = {h}_{ℓ}^{( 1 )} ( x ) + {h}_{ℓ}^{( 2 )} ( x ) + … + {h}_{ℓ}^{T} ( x ) , \qquad ( Eqn 1 )$$

in a forward stagewise manner to minimize the objective function. Forward stagewise fitting is a numerical procedure used when the exact minimization of the objective function is intractable. Under this procedure, a model is first fit with a single term hₗ⁽¹⁾(x), selected to minimize the objective function. At iteration t, a model is fit with t terms, where only the added term hₗ^{(t)}(x), is selected to minimize the objective function while keeping the previous terms unchanged.

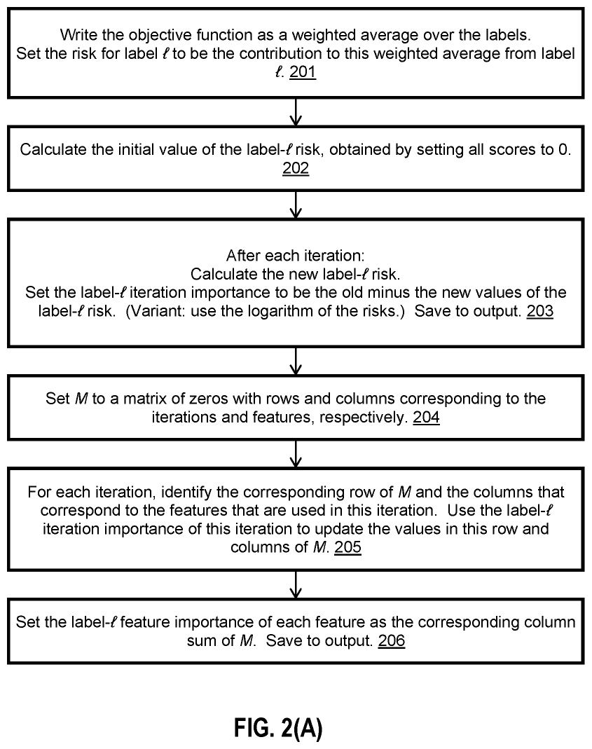

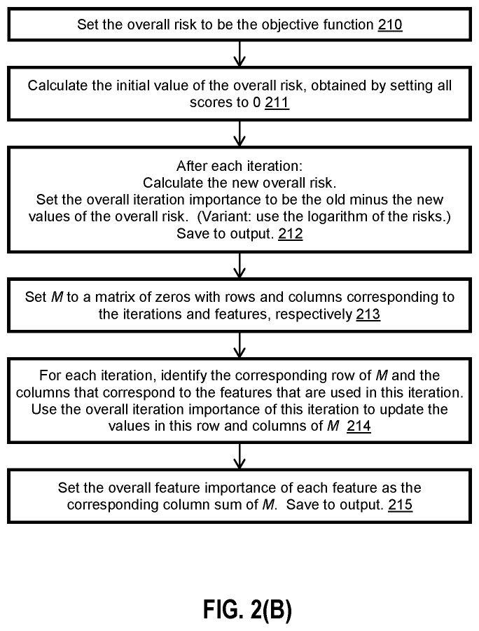

FIGS. 2(A) and 2(B) illustrate flowcharts to calculate the iteration importance and feature importance of a model that minimizes a multi-label objective function in an iterative manner, in accordance with an example implementation. FIG. 2(A) is for calculating these values for each label and FIG. 2(B) is for calculating these values for the overall model.

The inputs include a loss function that depends on the label vector y=(y₁, y₂, . . . , y_{K}) and the score vector (f₁(x), f₂(x), . . . , f_{K}(x)) and that can be written as a weighted average of terms each involving a single label. Each score fₗ(x) is a function of the feature vector x, and the components of x are called features. The inputs further include a model for the scores fₗ(x) that is fit iteratively to numerically minimize the weighted average of the loss function over the training data. The quantity being minimized is called the objective function.

The outputs include the overall iteration importance of each iteration, the label-l iteration importance of each iteration and each label l, the overall feature importance of each feature, and the label-l feature importance of each feature and each label l.

The flow of the diagram in FIG. 2(A) is as follows. At 201, the process writes the objective function as a weighted average over the K labels:

overall risk=objective function=Σₗ[(weight for label l)×(risk for label l)]

Example: The AdaBoost.MH Model Uses the Exponential Loss Function

$${\sum }_{ℓ = 1}^{K} {w}_{ℓ} exp ( - {f}_{ℓ} ( x ) {y}_{ℓ} ) ,$$

which leads to the objective function

$${\sum }_{i = 1}^{n} {\sum }_{ℓ = 1}^{K} {w}_{i ℓ} exp \{ - {f}_{ℓ} ( {x}_{i} ) {y}_{i ℓ} \} ,$$

where i denotes the i-th training example and {wₗ} and {wᵢₗ} are sets of weights that sum up to one. The objective function can be rewritten as

$${\sum }_{ℓ = 1}^{K} {w}_{ℓ} ( {\sum }_{i = 1}^{n} {\tilde{w}}_{i ℓ} exp \{ - {f}_{ℓ} ( {x}_{i} ) {y}_{i ℓ} \} ) ,$$

where wₗ=Σᵢwᵢₗ and \tilde{w}ᵢₗ=wᵢₗ/wₗ. The risk for label l is the expression within parentheses.

At 202, before the first iteration, all the scores fₗ(x) are treated as 0. The flow calculates the label-l risk. For the above example, these are all exp(0)=1.

At 203, after each iteration, the scores fₗ(x) are updated, which leads to a new value of the label-i risk. Set:

Overall iteration importance for this iteration=(old overall risk)−(new overall risk) (Eqn 2)

Label-l iteration importance for this iteration=(old label-l risk)−(new label-l risk) (Eqn 3)

The idea here is to use the risk reduction achieved in an iteration as a measure of its importance. Since the quantity being minimized is the overall risk, which is a weighted average of the risks for the K labels, an iteration will in general have different effects on the risks for different labels: for some labels there might be a greater reduction than the overall risk, while for others there might be a lesser reduction or even an increase.

As a variation, the logarithm of the risks in the definitions of iteration importance in Eqn 2 and Eqn 3 can be used to measure importance in terms of the relative risk reduction instead of the absolute risk reduction, depending on the desired implementation. To avoid inflating the risk reduction, the risks can be calculated by using a test set instead of the training set.

For some models, the iterative procedure updates the objective function after each iteration, to be used for the next iteration. The old risk values can be calculated using the objective function for the previous iteration or the current iteration, leading to different results. Such implementations are example variants that can be used in accordance with the desired implementation.

Example for AdaBoost.MH: It is known that each iteration decreases the overall risk by a factor ≤1. This factor is often expressed as

$$\sqrt{1 - {γ}^{2}} ,$$

where γ is a number between 0 and 1 called the edge of the iteration. Hence, using the logarithm variant,

$$Overall iteration importance = log [ ( old overall risk ) / ( new overall risk ) ] = - log \sqrt{1 - {γ}^{2}} . \qquad ( Eqn . 4 )$$

Moreover, if the current objective function is used to calculate the old risk values, it can be shown that

$$Label \text{-} ℓ iteration importance = - log [ ( 1 - γ {γ}_{ℓ} ) / \sqrt{1 - {γ}^{2}} ] . \qquad ( Eqn . 5 )$$

where γₗ is the edge of the iteration for label l. The quantities γ and γₗ are known concepts from the boosting literature and can be expressed in terms of the model parameters that are fit in each iteration. Here, a more convenient normalization for γₗ can be used that satisfies γ=Σₗwₗγₗ.

At 204, the flow sets M to a matrix of zeros with rows and columns corresponding to the iterations and features, respectively.

At 205, for each iteration, the flow uses the iteration importance for label l to assign weights to the features that are used in this iteration. The assigned weights are inserted into the corresponding row and columns of M.

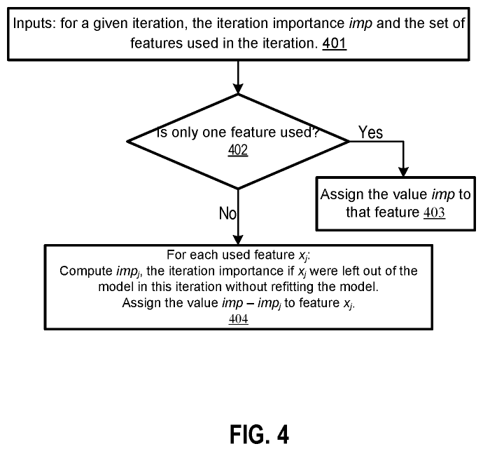

The assignment may be done using different methods. For example, a simple and fast method is to allocate the iteration importance equally among the features that are used. FIG. 4 illustrates an example assignment method in accordance with an example implementation.

At 206, the flow adds up the weights in each column of M and define that to be the label-l feature importance of the corresponding feature.

FIG. 2(B) illustrates an example detailed flow diagram for determining the overall feature importance value, in accordance with an example implementation. The flow illustrated herein as similar to the flow for calculating the feature importance for a particular label as illustrated in FIG. 2(A), only that the starting points are different.

At 210, the flow sets the overall risk to be the objective function. For overall feature importance, the example implementations utilize the objective function. Such an objective function (or the number obtained by evaluating it on a specific dataset) is described herein as the “overall risk”.

At 211, the flow calculates the initial value of the overall risk, obtained by setting all scores to 0. At 212, after each iteration, the flow calculates the new overall risk by taking a difference between the old and new values of the overall risk. The difference can be the absolute difference, or can be a logarithmic difference, or otherwise depending on the desired implementation. The difference is then saved to output.

At 213, the flow sets M to a matrix of zeros with rows and columns corresponding to the iterations and features, respectively. At 214, for each iteration, the flow identifies the corresponding row of M and the columns that correspond to the features that are used in this iteration. The flow utilizes the overall iteration importance of this iteration to update the weights in this row and columns of M as illustrated in FIG. 4. At 215, the flow sets the overall feature importance of each feature as the corresponding column sum of M and saves to output.

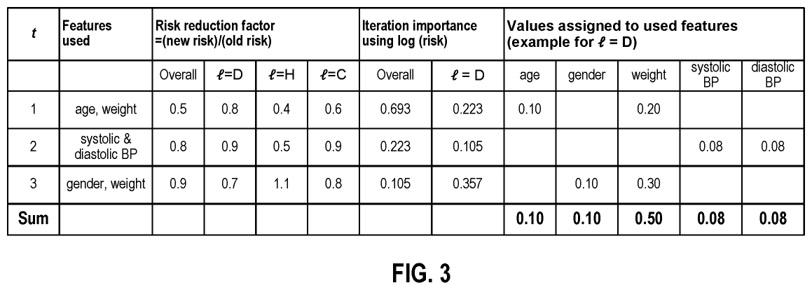

FIG. 3 illustrates an example output from the flow of FIGS. 2(A) and 2(B), in accordance with an example implementation. Specifically, FIG. 3 illustrates a model with three iterations. For each iteration: 1) the risk reduction factors are calculated; 2) they are used to obtain the iteration importance using the log(risk) variant of Eqn 2 and Eqn 3; and 3) the iteration importance is used to assign weights to the features used (unassigned weights are 0). The feature importance is the sum of the assigned weights over the iterations.

FIG. 4 illustrates an example assignment method in accordance with an example implementation. Specifically, FIG. 4 illustrates an example of the “leave-out” method for assigning weights to the features used in an iteration.

At 401, an input is provided for a given iteration, which involves the iteration importance imp (e.g., either overall or for a specific label), defined in terms of the risk (or the logarithm of the risk) as shown in Eqn 2 or Eqn 3. The input also involves the set of features that are used in the iteration. A model may use only a small number of features in each iteration. Examples are boosted or ensemble models that fit a decision tree of limited depth in each iteration.

At 402, a determination is made as to whether there is only one feature is used in this iteration or not. If so (Yes), then the flow proceeds to 403 to assign the iteration importance imp to that feature. Otherwise (No), the flow proceeds to 404 wherein for each used feature xⱼ, if that feature were left out of the model in this iteration without refitting the model, the scores fₗ(x) will be changed. Hence the risks will be changed, which will lead to a new value impⱼ of the iteration importance. The value imp−impⱼ is assigned to the feature xⱼ.

This definition is appealing because a feature xⱼ whose omission results in a larger drop in the iteration importance should be assigned a larger weight. Moreover, this definition is also consistent with the implementation of FIG. 1 if applied to a feature that is not used in the iteration: the omission of such a feature leaves the scores fₗ(x) and hence the iteration importance unchanged, leading to an assigned weight of 0.

Under this “leave-out” method, the assigned weights for all the used features may not add up to the iteration importance, unlike the method that allocates the iteration importance equally among the used features.

There is no standard definition for what the scores fₗ(x) would be if xⱼ were left out of the model without refitting the model. Examples of some possibilities are as follows:

a. If the model handles missing values, set xⱼ to missing for the current iteration and compute fₗ(x)

b. (Permutation method) Randomly permute the values of xⱼ in the training or test set (whichever is used to compute the risks), keeping the other features unchanged. Compute fₗ(x) when this is done for the current iteration.

For some models, there may be a natural way to define impⱼ. For example, consider an AdaBoost.MH model where the added term hₗ(x) in each iteration (see Eqn 1) only takes values ±a for some α>0 and the sign of hₗ(x) is the product of a feature-independent factor vₗ∈{−1,1} and a label-independent factor. Further, assume that the label-independent factor is a product of two decision stumps, so that

$${h}_{ℓ} ( x ) = α {v}_{ℓ} sgn ( {x}_{s ( 1 )} - {b}_{1} ) sgn ( {x}_{s ( 2 )} - {b}_{2} ) ,$$

where the split conditions for the decision stumps are xₛ₍₁₎≥b₁ and xₛ₍₂₎≥b₂ and sgn(u) equals 1 if u≥0 and −1 if u<0.

It can be shown that, for this iteration, the edge for label l is given by

$${γ}_{ℓ} = \vert {\sum }_{i} {\tilde{w}}_{i ℓ} sgn ( {x}_{s ( 1 )} - {b}_{1} ) sgn ( {x}_{s ( 2 )} - {b}_{2} ) {y}_{i ℓ} \vert$$

and the (overall) edge by γ=Σₗwₗγₗ. The features used in this iteration are xₛ₍₁₎ and xₛ₍₂₎. If xⱼ=xₛ₍₁₎ were left out of the model for this iteration, it is appealing to use the value \tilde{γ}ₗ=|Σᵢ\tilde{w}ᵢₗsgn(xₛ₍₂₎−b₂)yᵢₗ| as the edge for label l and \tilde{γ}=Σₗwₗ\tilde{γ}ₗ as the (overall) edge. From these, we can use the formulas (see Eqn 4 and Eqn 5).

$${imp}_{j} = - log \sqrt{1 - {\tilde{γ}}^{2}}$$

and

$${imp}_{j} = - log [ ( 1 - \tilde{γ} {\tilde{γ}}_{ℓ} ) / \sqrt{1 - {\tilde{γ}}^{2}} ]$$

to calculate the overall and label-l iteration importance, respectively, if xⱼ were left out of the model in this iteration without refitting the model.

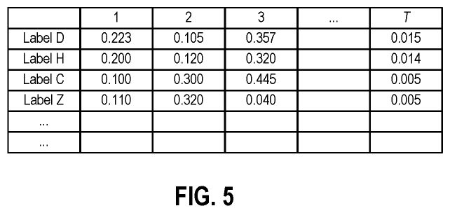

Depending on the desired implementation, labels can be clustered using iteration importance. One output of such a method is the matrix of iteration importance values as illustrated at 203 of FIG. 2(A). FIG. 5 illustrates an example of such a matrix, with rows corresponding to the labels (D, H, C, Z, . . . ) and columns to the iterations.

This matrix can be used to cluster the labels, by treating the Euclidean distance between any two rows as the dissimilarity between the corresponding two labels and applying a standard clustering method such as k-means or hierarchical clustering. (Another dissimilarity measure can be used in place of Euclidean distance.) The output is a grouping of the labels into k clusters, with the (approximate) property that labels within a cluster are more similar to one another than labels from different clusters. Two labels are similar if their risks change in similar ways over the iterations.

For the values shown in FIG. 5, labels D and H are more similar to each other than to either C or Z, and labels C and Z are more similar to each other than to either D or H. Hence, a clustering algorithm may put D and H in one cluster and C and Z in another.

With this definition, it is possible for two similar labels to have model scores that are negatively correlated. If such an outcome is to be avoided, columns can be added to the above similarity matrix that incorporate changes in the scores. For example, if each iteration contributes either +α or −α to the score for a label, the ±a contributions can be added to the matrix, giving T additional columns. With this expanded similarity matrix, similar labels would also tend to have positively correlated model scores.

Clustering labels can help us to understand their relationships. In addition, the clusters can be used to replace a multi-label problem by several smaller problems as follows: 1) group the original K labels into a number of clusters, with each cluster being a subset of similar labels; 2) create a model to predict the most likely subsets; 3) predict the most likely original labels within those likely subsets. This can be useful for computational and interpretability reasons. The clustering as described herein utilizes an initial model with K labels to calculate the similarity matrix. If computational complexity is an issue for this model, a simpler form can be used for the iterative updates hₗ(x), fewer iterations can be used, and so on in accordance with the desired implementation.

For multi-label approaches that transform the problem into multiple independent problems for predicting whether each label l is present or absent, there are many existing feature importance methods that one can apply to the resulting classification models to get their feature importance. However, there are no methods in the related art for calculating the feature importance for a general multi-label model that optimizes a multilabel objective function via an iterative procedure.

The example implementations described herein can be desirable because the same criterion is used for both model fitting and feature importance. The feature importance is based on the contribution to the overall objective function.

Further, for models that use only a small number of features in each iteration, the example implementations described herein only need to calculate the weights to assign to those features as illustrated in FIG. 3; the other features are assigned the weight 0.

In example implementations, the leave-out method for assigning weights to the features used in an iteration is better than the naïve method of equal allocation. For example, if an iteration uses two features, one of which is very rare, the rare feature should be assigned a smaller weight, which is the outcome of the leave-out method.

Further, the example implementations also calculate the iteration importance, which by themselves may be useful. The iteration importance for iteration t=1, 2, . . . , T can be treated as a vector and the distance between the label-l vector and the label-l′ vector as the dissimilarity between l and l′. This allows the example implementations to cluster the labels. Similar labels are potentially good candidates to be merged, which results in a multi-label problem with fewer labels.

Multi-label models that optimize a multi-label objective function in an iterative manner are common but often hard to interpret. This is a barrier to the adoption of machine learning models in practice. The example implementations can quantify how important each feature is for predicting each label, which can be used to improve model explainability and increase user confidence and acceptance. In addition, the iteration importance can be used to cluster the labels and reduce the number of labels for modeling.

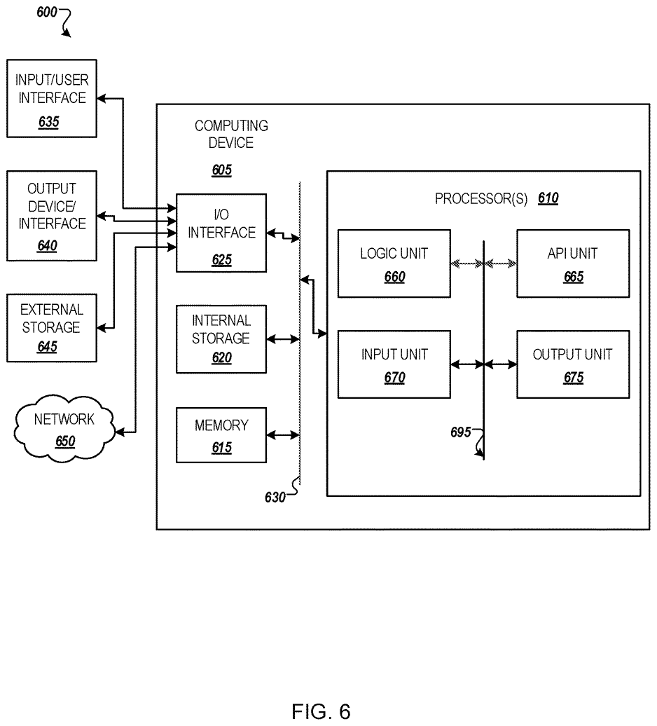

FIG. 6 illustrates an example computing environment with an example computer device suitable for use in some example implementations, such as an apparatus configured to determine feature importance values for each label for a multi-label model configured to provide model scores for each label in the multi-label model based on an input feature vector as described herein. Computer device 605 in computing environment 600 can include one or more processing units, cores, or processors 610, memory 615 (e.g., RAM, ROM, and/or the like), internal storage 620 (e.g., magnetic, optical, solid state storage, and/or organic), and/or IO interface 625, any of which can be coupled on a communication mechanism or bus 630 for communicating information or embedded in the computer device 605. IO interface 625 is also configured to receive images from cameras or provide images to projectors or displays, depending on the desired implementation.

Computer device 605 can be communicatively coupled to input/user interface 635 and output device/interface 640. Either one or both of input/user interface 635 and output device/interface 640 can be a wired or wireless interface and can be detachable. Input/user interface 635 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 640 may include a display, television, monitor, printer, speaker, braille, or the like. In some example implementations, input/user interface 635 and output device/interface 640 can be embedded with or physically coupled to the computer device 605. In other example implementations, other computer devices may function as or provide the functions of input/user interface 635 and output device/interface 640 for a computer device 605.

Examples of computer device 605 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 605 can be communicatively coupled (e.g., via IO interface 625) to external storage 645 and network 650 for communicating with any number of networked components, devices, and systems, including one or more computer devices of the same or different configuration. Computer device 605 or any connected computer device can be functioning as, providing services of, or referred to as a server, client, thin server, general machine, special-purpose machine, or another label.

IO interface 625 can include, but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 600. Network 650 can be any network or combination of networks (e.g., the Internet, local area network, wide area network, a telephonic network, a cellular network, satellite network, and the like).

Computer device 605 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 605 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 610 can execute under any operating system (OS) (not shown), in a native or virtual environment. One or more applications can be deployed that include logic unit 660, application programming interface (API) unit 665, input unit 670, output unit 675, and inter-unit communication mechanism 695 for the different units to communicate with each other, with the OS, and with other applications (not shown). The described units and elements can be varied in design, function, configuration, or implementation and are not limited to the descriptions provided. Processor(s) 610 can be in the form of hardware processors such as central processing units (CPUs) or in a combination of hardware and software units.

In some example implementations, when information or an execution instruction is received by API unit 665, it may be communicated to one or more other units (e.g., logic unit 660, input unit 670, output unit 675). In some instances, logic unit 660 may be configured to control the information flow among the units and direct the services provided by API unit 665, input unit 670, output unit 675, in some example implementations described above. For example, the flow of one or more processes or implementations may be controlled by logic unit 660 alone or in conjunction with API unit 665. The input unit 670 may be configured to obtain input for the calculations described in the example implementations, and the output unit 675 may be configured to provide output based on the calculations described in example implementations.

Processor(s) 610 can be configured to execute an objective function on the model scores for each label to determine a risk associated with each label; execute an iterative process involving the features represented in the input feature vector. For each iteration, the processor is configured to determine an iteration importance value for the each label for the each iteration from a risk reduction that is derived from the risk associated with the each label; and assign weights for the features associated with the each label based on the iteration importance value for that label for the each iteration as illustrated in the flow of FIG. 2(A) utilized to execute the iterations to generate the results shown in FIG. 3. Further, Weights can be determined through any desired implementation. As illustrated in FIG. 3 and FIG. 4, the weights do not necessarily need to sum up to the risk reduction difference, but can be implemented in other ways depending on the desired implementation, such as illustrated for assigning l=D as weighted to the features.

Processor(s) 610 can be configured to determine an iteration importance value for the each label for the each iteration from the risk reduction that is derived from the risk associated with the each label by executing the objective function for the each label to determine a new risk and calculating a difference between a previous risk and the new risk as the risk reduction as illustrated in FIG. 3, Eqn 2 and Eqn 3. As described herein, the difference can be an absolute difference, or can be based on a logarithmic difference depending on the desired implementation. The difference can thereby serve as the risk reduction as described herein.

Processor(s) 610 can be configured to assign the weights for the features associated with the each label by determining one or more features used by the model for the each iteration, the one or more features being a subset of features represented in the input feature vector; for the one or more features being a singular feature, assigning the iteration importance value for the each iteration to the singular feature; and for the one or more features involving a plurality of features, determining, for each feature, another iteration importance value determined through omission of the each feature, and assigning the difference between the iteration importance value and the another iteration importance value to the each feature as illustrated in FIG. 3 and FIG. 4. As described herein, different features can be utilized in different iterations.

Processor(s) 610 can be configured to aggregate the assigned weights for the each label to determine the feature importance values for the each label for the multi-label model as illustrated in the sum of values of FIG. 3.

Processor(s) 610 can be configured to determine overall feature importance value for each of the features in the input feature vector, the determining the overall feature importance value by: for the each iteration, calculating a new overall risk for the each label based on the iteration importance value; determining an overall iteration importance value from a difference between the new overall risk and a previous overall risk; updating a matrix relating the each iteration and the features with the overall iteration importance value corresponding to the each iteration and corresponding ones of the features represented in the input feature vector utilized in the each iteration; and determining the overall feature importance value for each of the features based on a summation of overall iteration importance values for the each features in the matrix as illustrated in FIG. 2(B). As described herein, the difference can be an absolute difference, or can be based on a logarithmic difference depending on the desired implementation.

Processor(s) 610 can be configured to execute a clustering algorithm on the iteration importance values for the labels to determine correlations between labels in the multi-label model as described with respect to the clustering implementations.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A computer implemented method for determining feature importance values for each label for a multi-label model configured to provide model scores for each label in the multi-label model based on an input feature vector, the method comprising:
executing an objective function on the model scores for each label to determine a risk associated with each label;
executing an iterative process involving the features represented in the input feature vector, wherein for each iteration:
determining an iteration importance value for the each label for the each iteration from a risk reduction that is derived from the risk associated with the each label; and
assigning weights for the features associated with the each label based on the iteration importance value for that label for the each iteration.

2. The computer implemented method of claim 1, wherein the determining an iteration importance value for the each label for the each iteration from the risk reduction that is derived from the risk associated with the each label comprises executing the objective function for the each label to determine a new risk and calculating a difference between a previous risk and the new risk as the risk reduction.

3. The computer implemented method of claim 1, wherein the assigning the weights for the features associated with the each label comprises:
determining one or more features used by the model for the each iteration, the one or more features being a subset of features represented in the input feature vector;
for the one or more features being a singular feature, assigning the iteration importance value for the each iteration to the singular feature; and
for the one or more features involving a plurality of features:
determining, for each feature, another iteration importance value determined through omission of the each feature, and
assigning the difference between the iteration importance value and the another iteration importance value to the each feature.

4. The computer implemented method of claim 1, further comprising aggregating the assigned weights for the each label to determine the feature importance values for the each label for the multi-label model.

5. The computer implemented method of claim 1, further comprising determining overall feature importance value for each of the features in the input feature vector, the determining the overall feature importance value comprising:
for the each iteration, calculating a new overall risk;
determining an overall iteration importance value from a difference between the new overall risk and a previous overall risk;
updating a matrix of weights relating the each iteration and the features with the overall iteration importance value corresponding to the each iteration and corresponding ones of the features represented in the input feature vector utilized in the each iteration; and
determining the overall feature importance value for each of the features based on a summation of weights for the each features in the matrix.

6. The computer implemented method of claim 1, further comprising executing a clustering algorithm on the iteration importance values for the labels to determine correlations between labels in the multi-label model.

7. A non-transitory computer readable medium, storing instructions for determining feature importance values for each label for a multi-label model configured to provide model scores for each label in the multi-label model based on an input feature vector, the instructions comprising:
executing an objective function on the model scores for each label to determine a risk associated with each label;
executing an iterative process involving the features represented in the input feature vector, wherein for each iteration:
determining an iteration importance value for the each label for the each iteration from a risk reduction that is derived from the risk associated with the each label; and
assigning weights for the features associated with the each label based on the iteration importance value for that label for the each iteration.

8. The non-transitory computer readable medium of claim 7, wherein the determining an iteration importance value for the each label for the each iteration from the risk reduction that is derived from the risk associated with the each label comprises executing the objective function for the each label to determine a new risk and calculating a difference between a previous risk and the new risk as the risk reduction.

9. The non-transitory computer readable medium of claim 7, wherein the assigning the weights for the features associated with the each label comprises:
determining one or more features used by the model for the each iteration, the one or more features being a subset of features represented in the input feature vector;
for the one or more features being a singular feature, assigning the iteration importance value for the each iteration to the singular feature; and
for the one or more features involving a plurality of features:
determining, for each feature, another iteration importance value determined through omission of the each feature, and
assigning the difference between the iteration importance value and the another iteration importance value to the each feature.

10. The non-transitory computer readable medium of claim 7, further comprising aggregating the assigned weights for the each label to determine the feature importance values for the each label for the multi-label model.

11. The non-transitory computer readable medium of claim 7, further comprising determining overall feature importance value for each of the features in the input feature vector, the determining the overall feature importance value comprising:
for the each iteration, calculating a new overall risk;
determining an overall iteration importance value from a difference between the new overall risk and a previous overall risk;
updating a matrix of weights relating the each iteration and the features with the overall iteration importance value corresponding to the each iteration and corresponding ones of the features represented in the input feature vector utilized in the each iteration; and
determining the overall feature importance value for each of the features based on a summation of weights for the each features in the matrix.

12. The non-transitory computer readable medium of claim 7, further comprising executing a clustering algorithm on the iteration importance values for the labels to determine correlations between labels in the multi-label model.

13. An apparatus configured to determine feature importance values for each label for a multi-label model configured to provide model scores for each label in the multi-label model based on an input feature vector, the apparatus comprising:
a processor, configured to:
execute an objective function on the model scores for each label to determine a risk associated with each label;
execute an iterative process involving the features represented in the input feature vector, wherein for each iteration, the processor is configured to:
determine an iteration importance value for the each label for the each iteration from a risk reduction that is derived from the risk associated with the each label; and
assign weights for the features associated with the each label based on the iteration importance value for that label for the each iteration.

14. The apparatus of claim 13, wherein the processor is configured to determine an iteration importance value for the each label for the each iteration from the risk reduction that is derived from the risk associated with the each label by executing the objective function for the each label to determine a new risk and calculating a difference between a previous risk and the new risk as the risk reduction.

15. The apparatus of claim 13, wherein the processor is configured to assign the weights for the features associated with the each label by:
determining one or more features used by the model for the each iteration, the one or more features being a subset of features represented in the input feature vector;
for the one or more features being a singular feature, assigning the iteration importance value for the each iteration to the singular feature; and
for the one or more features involving a plurality of features:
determining, for each feature, another iteration importance value determined through omission of the each feature, and
assigning the difference between the iteration importance value and the another iteration importance value to the each feature.

16. The apparatus of claim 13, wherein the processor is configured to aggregate the assigned weights for the each label to determine the feature importance values for the each label for the multi-label model.

17. The apparatus of claim 13, wherein the processor is configured to determine overall feature importance value for each of the features in the input feature vector, the determining the overall feature importance value by:
for the each iteration, calculating a new overall risk;
determining an overall iteration importance value from a difference between the new overall risk and a previous overall risk;
updating a matrix of weights relating the each iteration and the features with the overall iteration importance value corresponding to the each iteration and corresponding ones of the features represented in the input feature vector utilized in the each iteration; and
determining the overall feature importance value for each of the features based on a summation of weights for the each features in the matrix.

18. The apparatus of claim 13, wherein the processor is configured to execute a clustering algorithm on the iteration importance values for the labels to determine correlations between labels in the multi-label model.
